(19) United States
(12) Patent Application Publication
(10) Pub. No.: US 2025/0121343 A1
(43) Pub. Date: Apr. 17, 2025

(54) GAS-PHASE POLYMERIZATION APPARATUS

(71) Applicant: Basell Polyolefine GmbH, Wesseling (DE)

(72) Inventors: Pier Luigi Di Federico, Ferrara (IT); Riccardo Rinaldi, Ferrara (IT); Gian Luca Bonaccorsi, Ferrara (IT); Giuseppe Penzo, Mantova (IT); Maurizio Dorini, Ferrara (IT)

(73) Assignee: Basell Polyolefine GmbH, Wesseling (DE)

(21) Appl. No.: 18/568,207

(22) PCT Filed: Jun. 7, 2022
(86) PCT No.: PCT/EP2022/065427

§ 371 Date: Dec. 7, 2023

(30) Foreign Application Priority Data
Jun. 8, 2021 (EP) 21178384.0

(51) Int. Cl. B01J 8/44; B01J 8/18; B01J 19/00; B01J 19/24; C08F 10/00

(52) U.S. Cl. CPC B01J 8/44; B01J 8/1863; B01J 19/002; B01J 19/2465; C08F 10/00; B01J 2208/00548; B01J 2208/00707; B01J 2219/00103; B01J 2219/00164; B01J 2219/00247

(57) ABSTRACT

An apparatus for the gas-phase polymerization of olefins including a reactor having a polymerization zone, a recycle line for withdrawing reaction gas from the reactor and feeding the reaction gas back into the reactor, a compressor for conveying the reaction gas along the recycle line, and a heat exchanger for cooling the reaction gas, wherein at least part of the internal surface of the recycle line, which comes in contact with the reaction gas, has a surface roughness Ra of less than 5 μm.

### FIELD OF THE INVENTION

In general, the present disclosure relates to the field of chemistry. More specifically, the present disclosure relates to polymer chemistry. In particular, the present disclosure relates to an apparatus for the gas-phase polymerization of olefins and a process for preparing an olefin polymer carried out in the apparatus.

### BACKGROUND OF THE INVENTION

Polyolefins are derived from olefins such as ethylene and propylene.

In some instances, gas-phase polymerization processes produce polyolefins. In some instances, gas-phase polymerizations are carried out in fluidized-bed reactors, stirred gas-phase reactors, or multizone circulating reactors with two distinct interconnected gas-phase polymerization zones. In some instances, the components in the gas-phase reaction mixture are made from or containing monomers and comonomers, in the presence of a polymerization catalyst system. In some embodiments, the mixture is further made from or containing polymerization diluents, molecular weight modifier, or low-molecular weight reaction products. In some instances, the polymerization diluents are nitrogen or alkanes. In some instances, the molecular weight modifier is hydrogen. In some embodiments, the resulting products are solid polyolefin particles.

In some instances, gas is withdrawn from the reaction zone, passed through a heat-exchanger for removing the heat of polymerization, and returned to the polymerization zone. In fluidized-bed reactors, the returned reaction gas further serves to maintain the polyolefin particles in fluidized state. In multizone circulating reactors, the circulation between the reactor zones is effected by the returned reaction gas. In some instances, the recycle lines for the reaction gas are equipped with a centrifugal compressor.

In some instances, a challenge encountered in the gas-phase polymerization of polyolefins is the presence of polymer particles in the circulating reaction gas. In some instances, the polymer particles accumulate, thereby plugging of the equipment.

### SUMMARY OF THE INVENTION

In a general embodiment, the present disclosure provides an apparatus for the gas-phase polymerization of olefins, including
a reactor having a polymerization zone,
a recycle line for withdrawing reaction gas from the reactor and feeding the reaction gas back into the reactor,
a compressor for conveying the reaction gas along the recycle line and
a heat exchanger for cooling the reaction gas,
   wherein at least part of the internal surface of the recycle line, which comes in contact with the reaction gas, has a surface roughness Rₐ of less than 5 μm, determined according to ASME B46.1. In some embodiments, the surface roughness Rₐ is less than 3 μm.

In some embodiments, at least part of the internal surface of the recycle line is made of stainless steel, having a surface roughness Rₐ of less than 2.5 μm, alternatively less than 2 μm, determined according to ASME B46.1.

In some embodiments, at least part of the internal surface of the recycle line is made of low temperature carbon steel (LTCS), having a surface roughness Rₐ of less than 3 μm, determined according to ASME B46.1.

In some embodiments, the apparatus is free of protrusions on the surfaces coming into contact with the reaction gas, exceeding a height of 1.5 mm.

In some embodiments, the recycle line bend has a radius r larger than 5 times the diameter of the recycle line.

In some embodiments, the compressor is arranged up-stream of the heat exchanger.

In some embodiments, the compressor is an open-type centrifugal compressor having an impeller for increasing the pressure of the reaction gas, wherein the impeller has a surface roughness Rₐ of less than 3 μm, determined according to ASME B46.1.

In some embodiments, the apparatus has variable guide vanes arranged upstream of the compressor, wherein the surface of variable guide vanes, which comes into contact with the reaction gas, has a surface roughness Rₐ of less than 3 μm, determined according to ASME B46.1.

In some embodiments, the apparatus further has a butterfly valve arranged downstream of the heat exchanger, wherein the surface of the butterfly valve, which comes into contact with the reaction gas, has a surface roughness Rₐ of less than 3 μm, determined according to ASME B46.1.

In some embodiments, the butterfly valve has a rotational disc, having a smaller area than the cross-section of the recycle line at the location of the butterfly valve.

In some embodiments, the heat exchanger is a multitubular heat exchanger including an inlet chamber, a bundle of tubes encased in a shell structure, and an outlet chamber, wherein (a) each tube has an inlet with a diameter of d1, a longitudinal middle part with a diameter of d2, and an outlet, and (b) d1 is larger than d2.

In some embodiments, the reactor is a fluidized-bed reactor having a fluidized bed of polyolefin particles and a fluidization grid at the bottom of the reactor.

In some embodiments, the fluidization grid has a plurality of trays arranged to form (i) the lateral walls of an inverted cone and (ii) slots in the overlapping area of adjacent trays, wherein the trays have a surface roughness Ra of less than 3 μm, determined according to ASME B46.1.

In some embodiments, the overlapping area of a first tray forms the upper part of the slots, and the successive tray forms the bottom part of the slots.

In some embodiments, the apparatus is a multizone circulating reactor, wherein, in a first polymerization zone, growing polyolefin particles flow upwards under fast fluidization or transport conditions, wherein, in a second polymerization zone, growing polyolefin particles flow downward in a densified form, and wherein the first polymerization zone and the second polymerization zone are interconnected, polyolefin particles leaving the first polymerization zone enter the second polymerization zone, and polyolefin particles leaving the second polymerization zone enter the first polymerization zone, thereby establishing a circulation of polyolefin particles through the first and the second polymerization zones.

In some embodiments, the apparatus is part of a series of apparatuses.

In some embodiments, the present disclosure provides a process for preparing an olefin polymer including the step of homopolymerizing an olefin or copolymerizing an olefin and one or more other olefins at temperatures from 20 to 200° C. and pressures from 0.5 to 10 MPa, in the presence of a polymerization catalyst.

In some embodiments, the polymerization is a homopolymerization of ethylene or a copolymerization of ethylene and one or more other olefins selected from the group consisting of 1-butene, 1-hexene, and 1-octene. In some embodiments, the polymerization is a homopolymerization of propylene or a copolymerization of propylene and one or more other olefins selected from the group consisting of ethylene, 1-butene, and 1-hexene.

In some embodiments, the process is carried out at a reaction gas stream velocity of from 5 m/s to 25 m/s, alternatively from 15 m/s to 20 m/s.

In some embodiments, the fluidization velocity in the reactor is 0.3 to 1.5 m/s, alternatively 0.5 to 1.2 m/s.

### BRIEF DESCRIPTION OF THE DRAWINGS

FIG. 1 shows a schematic of an apparatus having a fluidized-bed reactor for carrying out a polymerization process.

FIG. 2 shows a schematic of an apparatus having a multizone circulating reactor for carrying out a polymerization process.

### DETAILED DESCRIPTION OF THE INVENTION

In a general embodiment, the present disclosure provides an apparatus for the gas-phase polymerization of olefins, including a reactor having a polymerization zone, a recycle line for withdrawing reaction gas from the reactor and feeding the reaction gas back to the reactor, a compressor for conveying the reaction gas along the recycle line, and a heat exchanger for cooling the reaction gas. In some embodiments, the reactors are selected from the group consisting of fluidized-bed reactors, stirred gas-phase reactors, and multizone circulating reactors with two distinct interconnected gas-phase polymerization zones. In some embodiments, stirred gas-phase reactors are horizontally or vertically stirred. In some embodiments, the gas-phase polymerization reactors are selected from the group consisting of fluidized-bed reactors and multizone circulating reactors.

In some embodiments, the olefins for polymerization are 1-olefins. As used herein, the term “1-olefins” refers to hydrocarbons having terminal double bonds, without being restricted thereto. In some embodiments, the olefins are nonpolar olefinic compounds. In some embodiments, the 1-olefins are linear C₂-C₁₂-1-alkenes, branched C₂-C₁₂-1-alkenes, conjugated dienes, or nonconjugated dienes. In some embodiments, the linear alkenes are C₂-C₁₀-1-alkenes. In some embodiments, the linear C₂-C₁₀-1-alkenes are selected from the group consisting of ethylene, propylene, 1-butene, 1-pentene, 1-hexene, 1-heptene, 1-octene, and 1-decene. In some embodiments, the branched alkenes are C₂-C₁₀-1-alkenes. In some embodiments, the branched C₂-C₁₀-1-alkene is 4-methyl-1-pentene. In some embodiments, the dienes are selected from the group consisting of 1,3-butadiene, 1,4-hexadiene, and 1,7-octadiene. In some embodiments, mixtures of various 1-olefins are polymerized. In some embodiments, the olefins have the double bond as part of a cyclic structure which can have one or more ring systems. In some embodiments, the olefins, including a cyclic structure, are selected from the group consisting of cyclopentene, norbornene, tetracy clododecene, methy Inorbornene, 5-ethylidene-2-norbornene, norbornadiene, and ethylnorbornadiene. It is also possible to polymerize mixtures of two or more olefins.

In some embodiments, the apparatuses are for the homopolymerization or copolymerization of ethylene or propylene, alternatively for the homopolymerization or copolymerization of ethylene. In some embodiments, comonomers in propylene polymerization are up to 40 wt. % of ethylene, 1-butene, or 1-hexene, alternatively from 0.5 wt. % to 35 wt. % of ethylene, 1-butene, or 1-hexene. In some embodiments, comonomers in ethylene polymerization are up to 20 wt. %, alternatively from 0.01 wt. % to 15 wt. %, alternatively from 0.05 wt. % to 12 wt. % of C₃-C₈-1-alkenes. In some embodiments, the alkene is selected from the group consisting of 1-butene, 1-pentene, 1-hexene, or 1-octene. In some embodiments, ethylene is copolymerized with from 0.1 wt. % to 12 wt. % of 1-hexene or 1-butene.

In some embodiments, the apparatus has at least part, alternatively the entirety, of the internal surface of the recycle line, which comes in contact with the reaction gas, has a surface roughness Rₐ of less than 5 μm, alternatively less than 3 μm, determined according to ASME B46.1. In some embodiments, the compressor conveys the reaction gas along the recycle line, thereby effecting withdrawal of the reaction gas from the reactor, passing of the reaction gas through the heat exchanger, feeding the reaction gas back into the reactor, and circulating the reaction gas. In some embodiments, the recycle line with an internal surface having a surface roughness Rₐ of less than 5 μm minimizes accumulation of polymer particles in the recycle line, thereby reducing the risk of plugging of the recycle line and disrupting the manufacturing process.

In some embodiments, the surface roughness is lower than 5 μm and the apparatus operates with a continuous circulation of fine particles. In some embodiments, a gas-phase polymerization of olefins operates without a gas/solid separation device such as a cyclone. In some embodiments, the head of the reactor has a broadened inner diameter compared to the bottom, thereby reducing the gas flow velocity and avoiding the entraining small particles into the recycle line. In some embodiments, the reactor does not have a broadened head. In some embodiments, the small particles flow through the recycle line back into the reactor without sticking to the internal surface of the recycle line. In some embodiments, the recycle line is free of a cyclone. In some embodiments, the recycle line is free of a cyclone upstream of the compressor or the heat-exchanger.

In some embodiments, the surface roughness Rₐ is provided by polishing, alternatively mechanical polishing or electropolishing.

In some embodiments, the different components of the apparatus for the gas-phase polymerization of olefins, alternatively the recycle line, are made of a durable material which does not interfere with the polymerization reaction and withstands the reaction conditions of high temperatures and pressures. In some embodiments, at least part of the recycle line and the equipment installed in the recycle line, alternatively the entirety of the recycle line and the equipment installed in the recycle line, is made of steel, alternatively stainless steel, alternatively low temperature carbon steel. In some embodiments, the durable material is stainless steel and the internal surface in contact with the reaction gas has a surface roughness Rₐ of less than 2.5 μm, alternatively less than 2 μm, determined according to ASME B46.1. In some embodiments, the recycle line and at least part of the equipment installed in the recycle line is made of low temperature carbon steel (LTCS) and the internal surface of the low temperature carbon steel in contact with the reaction gas has a surface roughness Rₐ of less than 3 μm, determined according to ASME B46.1.

In some embodiments, the apparatus is free of protrusions on the surfaces coming into contact with the reaction gas, exceeding a height of 1.5 mm.

In some embodiments, the recycle line prevent attachment of polymer fines to the internal surfaces, unwanted polymerization, and the generation of sheets or plugs that block the process of fluidization. In some embodiments, the recycle line is free of sharp turns or angles. In some embodiments, bends in the recycle line have a long diameter, thereby reducing the attrition of the recirculating polymer fines and limiting centrifugal forces to the walls. In some embodiments, the radius r of the bend in the recycle line is larger than diameter of the recycle line. In some embodiments, the recycle line bends have a radius r larger than 5 times the diameter d of the recycle line. In some embodiments, the bend-radius to recycle-line-diameter ratio is expressed as r>5 d.

In some embodiments, the apparatus further includes a compressor, alternatively a centrifugal compressor, for conveying the reaction gas along the recycle line. In some embodiments, the compressor is arranged upstream of the heat exchanger. In some embodiments, parts of the compressor's surface, which come into contact with the reaction gas, have a surface roughness Rₐ of less than 3 μm, determined according to ASME B46. 1. In some embodiments, the compressor is equipped with an impeller. In some embodiments, the compressor is an open-type centrifugal compressor having an impeller. In some embodiments, the impeller has a surface roughness Rₐ of less than 3 μm, determined according to ASME B46.1.

In some embodiments, the apparatus further includes variable guide vanes arranged upstream of the compressor. In some embodiments, the surface of the variable guide vanes. which comes into contact with the reaction gas, has a surface roughness Rₐ of less than 3 μm, determined according to ASME B46.1.

In some embodiments, the apparatus further includes a heat exchanger for cooling the reaction gas. In some embodiments, parts of the heat exchanger's surface, which come into contact with the reaction gas, have a surface roughness Rₐ of less than 7 μm, alternatively less than 3 μm, alternatively less than 2 μm, determined according to ASME B46.1. In some embodiments, the heat exchanger is a tube-shell heat exchanger. In some embodiments, the inner surfaces of the inlet chamber, of the tubes, and of the outlet chamber of the tube-shell heat exchanger have a surface roughness Rₐ of less than 7 μm, alternatively less than 3 μm, alternatively less than 2 μm, determined according to ASME B46.1.

In some embodiments, the heat exchanger is a multitubular heat exchanger having an inlet chamber, a bundle of tubes encased in a shell structure, and an outlet chamber, wherein (a) each tube has an inlet with a diameter of d1, a longitudinal middle part with a diameter of d2, and an outlet, and (b) d1 is larger than d2. In some embodiments, polymer particles present in the gas stream are guided through the pipes of the heat exchanger, thereby reducing the risk of accumulation and fouling. In some embodiments, the ratio of the dimeter d1 to the diameter d2 is from 1.75:1 to 1.5:1, alternatively from 1.4:1 to 1.3:1. In some embodiments, the inlet of each tube has a conical shape. In some embodiments, the angle between the cone area and the central axis of the tube is in the range from 20° to 60°, alternatively from 30° to 50°, alternatively 45°. In some embodiments, the inlet of each tube has a diameter d1 of from 25 mm to 45 mm, alternatively from 30 mm to 40 mm. As used herein, the term “inlet diameter” refers to the inner diameter and is defined for the inlets of the tubes as any straight line segment that passes through the center of the circle defined by the periphery of the tube inlet at inlet's broadest expansion and whose end points lay in the circle. In some embodiments, the diameter d2 of the longitudinal middle part of each tube, that is, the inner diameter of the longitudinal middle part of each tube, is from 10 mm to 30 mm, alternatively from 15 to 25mm. In some embodiments, the longitudinal middle part of the tubes has a constant diameter.

In some embodiments, the apparatus further includes a butterfly valve arranged downstream of the heat exchanger. In some embodiments, a butterfly valve controls the flow rate of the reaction gas in the recycle line, thereby establishing a variable pressure drop in the recycle line while having a low risk of fouling. In some embodiments, the butterfly valve is free of sharp edges and corners, thereby minimizing the risk adhering small particles, which are entrained in the reaction gas, to parts of the butterfly valve. In some embodiments, the surface of the butterfly valve, which comes into contact with the reaction gas, has a surface roughness Rₐ of less than 3 μm, determined according to ASME B46.1. In some embodiments, the butterfly valve includes a rotational disk, having a smaller area than the cross-section of the recycle line at the location of the butterfly valve. As such, when the butterfly valve is in fully closed position, that is, the rotational disc is positioned perpendicular to the gas flow, the gas flow is not fully blocked. In some embodiments, the area of the rotational disc is from 90% to 99% of the cross-section of the recycle line at the location of the butterfly valve, alternatively the area of the rotational disc is from 94% to 98% of the cross-section of the recycle line at the location of the butterfly valve. In some embodiments, the rotational disc is circular and the non-blocked area of the recycle line at the location of the butterfly valve in closed position forms an annular gap around the rotational disc. In some embodiments, the rotational disc is centrically fixed and rotates around an axis running through the center of the rotational disc. In some embodiments, the rotational disk has a surface roughness Rₐ of less than 3 μm, determined according to ASME B46.1.

In some embodiments, the apparatus includes a reactor which is a fluidized-bed reactor having a fluidized bed of polyolefin particles, a fluidization grid at the bottom of the reactor, and optionally a velocity reduction zone at the top part of the reactor. In some embodiments, the reactor allows for a constant flow of reaction gas and a stable fluidized bed of polyolefin particles.

Fluidized-bed reactors are reactors, wherein the polymerization takes place in a bed of polyolefin particles which is maintained in a fluidized state by feeding a reaction gas mixture into a reactor at the lower end of the reactor and withdrawing the gas again at the top of the fluidized-bed reactor. In some instances, the reaction gas mixture is fed into the reactor below a gas distribution grid, having the function of dispensing the gas flow. The reaction gas mixture is then returned to the lower end of the reactor via a recycle line equipped with a compressor and a heat exchanger for removing the heat of polymerization. The flow rate of the reaction gas fluidizes the bed of finely divided polymer particles in the polymerization zone and removes the heat of polymerization.

In some embodiments, the fluidization grid plurality of trays arranged to form (i) the lateral walls of an inverted cone and (ii) slots in the overlapping area of adjacent trays, wherein the trays have a surface roughness Rₐ of less than 3 μm, determined according to ASME B46.1. In some embodiments, the overlapping area of a first tray forms the upper part of the slots, and the successive tray forms the bottom part of the slots. In some embodiments, the grids distribute an upward gas flow in a homogenous way into a vessel containing a polymer in fluidized conditions. In some embodiments, the arrangements of the trays are as described in Patent Cooperation Treaty Publication No. WO 2008/074632 A1.

In some embodiments, the fluidized-bed reactor is equipped with a settling pipe. In some embodiments, the settling pipe's upper opening is integrated into the gas distribution grid. In some embodiments, the gas distribution grid and the settling pipe are arranged such that the gas distribution grid has a cone shape with a downward inclination toward the settling pipe, thereby fostering entry of the polyolefin particles into the settling pipe due to gravity.

In some embodiments, the fluidization velocity in the fluidized-bed reactor is from 0.3 to 1.5 m/s, alternatively from 0.5 to 1.2 m/s, thereby providing a homogenous and stable bed of fluidized polymer particles.

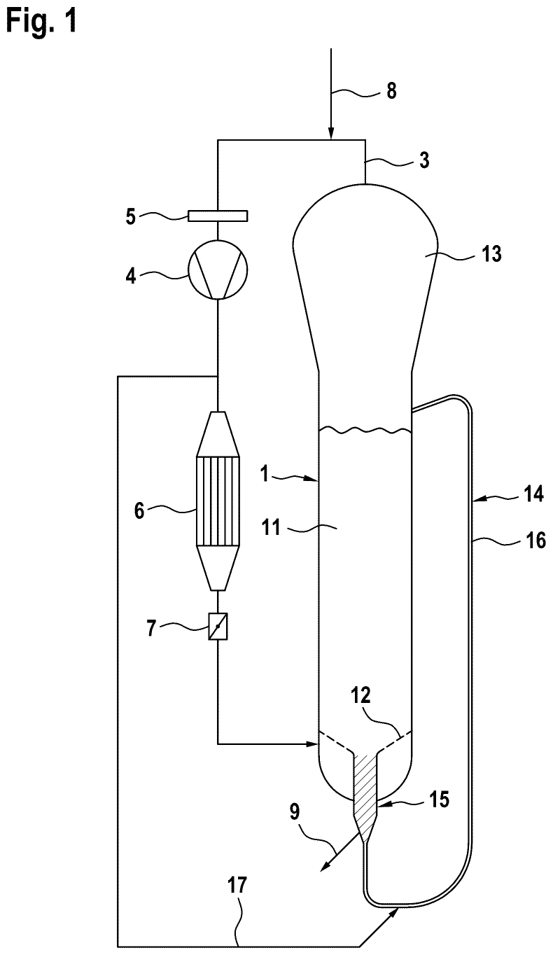

FIG. 1 shows a schematic of an apparatus having a fluidized-bed reactor.

Fluidized-bed reactor (1) includes a fluidized bed (11) of polyolefin particles, a gas distribution grid (12), and a velocity reduction zone (13), having an increased diameter compared to the diameter of the fluidized-bed portion of the reactor. The polyolefin bed is kept in a fluidization state by an upwardly flow of gas fed through the gas distribution grid (12) placed at the bottom of reactor (1). The gaseous stream of the reaction gas leaving the top of the velocity reduction zone (13) via the recycle line (3) is compressed by the compressor (4), having variable guide vanes (5), transferred to a heat exchanger (6), wherein the reaction gas is cooled, and then recycled to the bottom of the fluidized-bed reactor (1) at a point below the gas distribution grid (12). The recycle line (3) further has, downstream from the heat exchanger (6), a butterfly valve (7). In some embodiments, make-up monomer, molecular weight regulators, and optional inert gases or process additives are fed into the reactor (1) at various positions. In some embodiments, components are fed via line (8) upstream of the compressor (4).

The fluidized-bed reactor (1) is provided with a continuous pneumatic recycle of polyolefin particles by a circulation loop (14), connecting the gas distribution grid (12) to the upper region of the fluidized-bed reactor (1). The circulation loop (14) includes a settling pipe (15) and a pneumatic conveyor pipe (16). The upper opening of the settling pipe (15) is integrated with the gas distribution grid (12). In some embodiments, the settling pipe is arranged vertical. The gas distribution grid (12) has a cone shape, such that the cone's downward inclination towards the settling pipe (15) fosters the entry of the polyolefin particles into the settling pipe (15) due to gravity. In some embodiments, the upper opening of the settling pipe (15) is located in a central position with respect to the gas distribution grid (12). The carrier gas fed via line (17) for transporting the polyolefin particles through the pneumatic conveyor pipe (16) is taken from the gas recycle line at a point downstream of the compressor (4) and upstream the heat exchanger (6). The discharge of polyolefin particles from the fluidized-bed reactor (1) occurs from the settling pipe (15) through discharge conduit (9).

In some embodiments, the apparatus includes a multizone circulating reactor, wherein, in a first polymerization zone, growing polyolefin particles flow upward under fast fluidization or transport conditions, wherein, in a second polymerization zone, growing polyolefin particles flow downward in a densified form, and wherein the first polymerization zone and the second polymerization zone are interconnected, polyolefin particles leaving the first polymerization zone enter the second polymerization zone, and polyolefin particles leaving the second polymerization zone enter the first polymerization zone, thereby establishing a circulation of polyolefin particles through the first and second polymerization zone.

In some embodiments, the multizone circulating reactors are as described in Patent Cooperation Treaty Publication Nos. WO 97/04015 A1 and WO 00/02929 A1. In some embodiments, the multizone circulating reactors have two interconnected polymerization zones: (i) a riser, wherein the growing polyolefin particles flow upward under fast fluidization or transport conditions, and (ii) a downcomer, wherein the growing polyolefin particles flow downward in a densified form under the action of gravity. The polyolefin particles leaving the riser enter the downcomer, and the polyolefin particles leaving the downcomer are reintroduced into the riser, thereby establishing a circulation of polymer between the two polymerization zones. In some embodiments, the polymer is passed alternately a plurality of times through these two zones. In such polymerization reactors, a solid/gas separator is arranged above the downcomer to separate the polyolefin and reaction gaseous mixture coming from the riser. The growing polyolefin particles enter the downcomer, and the separated reaction gas mixture of the riser is continuously recycled through a gas recycle line to one or more points of reintroduction into the polymerization reactor. In some embodiments, the larger part of the recycle gas is recycled to the bottom of the riser. The recycle line is equipped with a centrifugal compressor and a heat exchanger for removing the heat of polymerization. In some embodiments, a line for feeding catalyst or a line for feeding polyolefin particles coming from an upstream reactor is arranged at the riser and a polymer discharge system is located in the bottom portion of the downcomer. In some embodiments, make-up monomers, comonomers, hydrogen or inert components are introduced at various points along the riser and the downcomer.

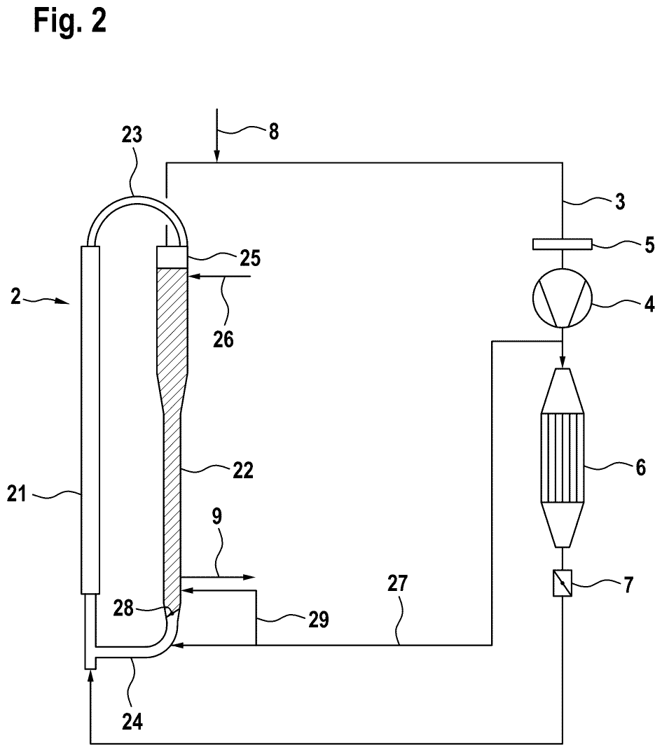

FIG. 2 shows a schematic of an apparatus having a multizone circulating reactor.

The multizone circulating reactor (2) includes a riser (21) as first reaction zone and a downcomer (22) as second reaction zone. The riser (21) and the downcomer (22) are repeatedly passed by the polyolefin particles. Within riser (21), the polyolefin particles flow upward under fast fluidization conditions. Within the downcomer (22), the polyolefin particles flow downward under the action of gravity. The riser (21) and the downcomer (22) are appropriately interconnected by the interconnection bends (23) and (24).

After flowing through the riser (21), the polyolefin particles and the reaction gas mixture leave riser (21) and are conveyed to a solid/gas separation zone (25). In some instances, the solid/gas separation is effected by a centrifugal separator. In some instances, the centrifugal separator is a cyclone. From the separation zone (25) the polyolefin particles move downwards into the downcomer (22). In some instances, a barrier fluid for preventing the reaction gas mixture of the riser (21) from entering the downcomer (22) is fed into a top part of the downcomer (22) via line (26).

The reaction gas mixture leaving the separation zone (25) is recycled to the bottom of the riser (21) by a recycle line (3), equipped with a compressor (4) having variable guide vanes (5), thereby establishing fast fluidization conditions in the riser (21). The recycle line (3) further includes a heat exchanger 6) and a butterfly valve (7) downstream of heat exchanger (6). In some instances, make-up monomers, make-up comonomers, and optionally inert gases or process additives are fed into the reactor (2) at various positions. In some instances, the components are fed via line (8) into the recycle line (3). Between the compressor (4) and the heat exchanger (6), a line (27) branches off and conveys a part of the recycle gas into the interconnection bend (24) for transporting the polyolefin particle from the downcomer (22) to the riser (21).

The bottom of the downcomer (22) is equipped with a butterfly valve (28) having an adjustable opening for adjusting the flow of polyolefin particles from downcomer (22) through interconnection bend (24) into the riser (21). Above the butterfly valve (28), amounts of a recycle gas mixture coming from the recycle line (3) through lines (26) and (29) are introduced as dosing gas into the downcomer (22), thereby facilitating the flow of the polyolefin particles through butterfly valve (28). The discharge of polyolefin particles from the multizone circulating reactor (2) occurs from the downcomer (22) through discharge conduit (9).

In some embodiments, the apparatus is part of a series of apparatuses. In some embodiments, the series includes a first gas-phase apparatus and a subsequent second gas-phase apparatus.

In some embodiments, the present disclosure provides a process for preparing an olefin polymer includes the step of homopolymerizing an olefin or copolymerizing an olefin and one or more other olefins at temperatures from 20 to 200° C. and pressures from 0.5 to 10 MPa, in the presence of a polymerization catalyst.

In some embodiments, the polymerization is a homopolymerization of ethylene or a copolymerization of ethylene and one or more other olefins selected from the group consisting of 1-butene, 1-hexene and 1-octene. In some embodiments, the polymerization is a homopolymerization of propylene or a copolymerization of propylene and one or more other olefins selected from the group consisting of ethylene, 1-butene and 1-hexene. In some embodiments, the resulting polyolefin is a high-density polyethylene, having a density determined according to ISO 1183 at 23° C. from 0.945 to 965 g/cm³.

In some embodiments, the process is carried out at pressures of from 0.5 MPa to 10 MPa, alternatively from 1.0 MPa to 8 MPa, alternatively from 1.5 MPa to 4 MPa. As used herein, pressures refer to absolute pressures, that is, pressure having the dimension MPa (abs). In some embodiments, the polymerization is carried out at temperatures of from 30°° C. to 160° C., alternatively from 65° C. to 125° C. In some embodiments and for preparing ethylene copolymers of relatively high density, the temperatures are in the upper part of the range. In some embodiments and for preparing ethylene copolymers of lower density, the temperatures are in the lower part of the range.

In some embodiments, the process is carried out in a condensing or super-condensing mode, wherein part of the circulating reaction gas mixture is cooled to below the dew point and returned to the reactor (a) separately as a liquid and a gas or (b) together as a liquid-gas phase mixture, thereby making additional use of the enthalpy of vaporization for cooling the reaction gas. In some embodiments, the process is operated in a condensing or super-condensing mode and carried out in a fluidized-bed reactor.

In some embodiments, the polymerization is carried out in the presence of an inert gas such as nitrogen or an alkane having from 1 to 10 carbon atoms. In some embodiments, the alkane is selected from the group consisting of methane, ethane, propane, n-butane, isobutane, n-pentane, isopentane, n-hexane, and mixtures thereof. In some embodiments, the inert gas is nitrogen or propane. In some embodiments, nitrogen or propane is used in combination with further alkanes. In some embodiments, the polymerization is carried out in the presence of a C₃-C₅ alkane as polymerization diluent, alternatively in the presence of propane. In some embodiments, the polymerization is for the homopolymerization or copolymerization of ethylene. In some embodiments, the reaction gas mixtures within the reactor are made from or containing the olefins to be polymerized and one or more optional comonomers. In some embodiments, the reaction gas mixture has a content of inert components from 30 to 99 vol. %, alternatively from 40 to 95 vol. %, alternatively from 45 to 85 vol. %. In some embodiments, no or minor amounts of inert diluent are added. In some embodiments, the monomer to be polymerized is propylene. In some embodiments, the reaction gas mixture is further made from or containing additional components or molecular weight regulators. In some embodiments, the additional components are antistatic agents. In some embodiments, the molecular weight regulator is hydrogen. In some embodiments, the components of the reaction gas mixture are fed into the gas-phase polymerization reactor or into the recycle line in gaseous form or as liquid which then vaporizes within the reactor or the recycle line.

In some embodiments, the polymerization of olefins is carried out using olefin polymerization catalysts. In some embodiments, the polymerization is carried out using Phillips catalysts based on chromium oxide, using Ziegler-or Ziegler-Natta-catalysts, or using single-site catalysts. As used herein, the term “single-site catalysts” refers to catalysts based on chemically uniform transition metal coordination compounds. In some embodiments, mixtures of two or more of these catalysts are used for the polymerization of olefins. In some embodiments, mixed catalysts are referred to as hybrid catalysts.

In some embodiments, the catalysts are of the Ziegler type. In some embodiments, the catalysts of the Ziegler or Ziegler-Natta type are made from or containing a compound of titanium or vanadium, a compound of magnesium and optionally an electron donor compound or a particulate inorganic oxide as a support material.

In some embodiments, catalysts of the Ziegler type are polymerized in the presence of a cocatalyst. In some embodiments, the cocatalysts are organometallic compounds of metals of Groups 1, 2, 12, 13 or 14 of the Periodic Table of Elements, alternatively organometallic compounds of metals of Group 13, alternatively organoaluminum compounds. In some embodiments, the cocatalysts are selected from the group consisting of organometallic alkyls, organometallic alkoxides, and organometallic halides.

In some embodiments, the organometallic compounds are selected from the group consisting of lithium alkyls, magnesium alkyls, zinc alkyls, magnesium alkyl halides, aluminum alkyls, silicon alkyls, silicon alkoxides, and silicon alkyl halides. In some embodiments, the organometallic compounds are selected from the group consisting of aluminum alkyls and magnesium alkyls. In some embodiments, the organometallic compounds are aluminum alkyls, alternatively trialkylaluminum compounds or compounds of this type wherein an alkyl group is replaced by a halogen atom. In some embodiments, the halogen atom is chlorine or bromine. In some embodiments, the aluminum alkyls are selected from the group consisting of trimethylaluminum, triethylaluminum, tri-isobutylaluminum, tri-n-hexylaluminum, diethylaluminum chloride, and mixtures thereof.

In some embodiments, the catalysts are Phillips-type chromium catalysts. In some embodiments, the Phillips-type chromium catalysts are prepared by applying a chromium compound to an inorganic support and subsequently activating the obtained catalyst precursor at temperatures in the range from 350 to 1000° C., thereby converting chromium present in valences lower than six into the hexavalent state. In some embodiments, an element other than chromium is used and selected from the group consisting of magnesium, calcium, boron, aluminum, phosphorus, titanium, vanadium, zirconium, and zinc. In some embodiments, the element is selected from the group consisting of titanium, zirconium, and zinc. In some embodiments, the elements are used in combinations. In some embodiments, the catalyst precursor is doped with fluoride prior to or during activation. In some embodiments, supports for Phillips-type catalysts are made from or containing aluminum oxide, silicon dioxide (silica gel), titanium dioxide, zirconium dioxide, mixed oxides thereof, cogels thereof, or aluminum phosphate. In some embodiments, support materials are obtained by modifying the pore surface area. In some embodiments, the pore surface area is modified using compounds of the elements boron, aluminum, silicon, or phosphorus. In some embodiments, the pore surface area is modified using a silica gel. In some embodiments, the pore surface area is modified using spherical or granular silica gels. In some embodiments, the spherical silica gels are spray dried. In some embodiments, the activated chromium catalysts are subsequently prepolymerized or prereduced. In some embodiments, the prereduction is carried out with cobalt or hydrogen at 250°° C. to 500° C., alternatively at 300° C. to 400° C., in an activator.

In some embodiments, the polymerization occurs in a gas-phase reactor which is part of a cascade of polymerization reactors. In some embodiments, one or more polymerizations occur in other gas-phase reactors of the cascade of polymerization reactors. In some embodiments, the combinations of polymerizations reactors are selected from the group consisting of a fluidized-bed reactor followed by a multizone circulating reactor, a multizone circulating reactor followed by a fluidized-bed reactor, a cascade of two or three fluidized-bed reactors, and one or two loop reactors followed by one or two fluidized-bed reactors.

In some embodiments, the process is carried out at a reaction gas stream velocity in the recycle line of from 5 m/s to 25 m/s, alternatively from 15 m/s to 20 m/s.

In some embodiments, the gas-phase polymerization of olefins is operated in the absence of a gas/solid separation device such as a cyclone. In some embodiments, the recycle line is not equipped with a cyclone, alternatively upstream of the compressor and the heat exchanger. In some embodiments, the start-up of the polymerization occurs with an empty reactor, that is, without the introduction of a seed bed of polymer particles before starting the polymerization.

1. An apparatus for the gas-phase polymerization of olefins, the apparatus comprising
a reactor comprising a polymerization zone;
a recycle line for withdrawing reaction gas from the reactor and feeding the reaction gas back into the reactor;
a compressor for conveying the reaction gas along the recycle line; and
a heat exchanger for cooling the reaction gas,
wherein at least part of the internal surface of the recycle line, which comes in contact with the reaction gas has a surface roughness Rₐ of less than 5 μm, determined according to ASME B46.1.

2. The apparatus of claim 1, wherein at least part of the internal surface of the recycle line is made of stainless steel, having a surface roughness Rₐ of less than 2.5 μm, determined according to ASME B46.1.

3. The apparatus of claim 1, wherein at least part of the internal surface of the recycle line is made of low temperature carbon steel (LTCS), having a surface roughness Ra of less than 3 μm, determined according to ASME B46.1.

4. The apparatus of claim 1, wherein the apparatus is free of protrusions on the surfaces coming into contact with the reaction gas, exceeding a height of 1.5 mm.

5. The apparatus of claim 1, the recycle line bend has a radius r larger than 5 times the diameter of the recycle line.

6. The apparatus of claim 1, wherein the compressor is an open-type centrifugal compressor comprising an impeller for increasing the pressure of the reaction gas, wherein the impeller has a surface roughness Ra of less than 3 μm, determined according to ASME B46.1.

7. The apparatus of claim 6, wherein the apparatus comprises variable guide vanes arranged upstream of the compressor, wherein the surface of variable guide vanes, which comes into contact with the reaction gas, has a surface roughness Ra of less than 3 μm, determined according to ASME B46.1.

8. The apparatus of claim 1, wherein the apparatus further comprises a butterfly valve arranged downstream of the heat exchanger, wherein the surface of the butterfly valve, which comes into contact with the reaction gas, has a surface roughness Ra of less than 3 μm, determined according to ASME B46.1.

9. The apparatus of claim 8, wherein the butterfly valve comprises a rotational disc, having a smaller area than the cross-section of the recycle line at the location of the butterfly valve.

10. The apparatus of claim 1, wherein the heat exchanger is a multitubular heat exchanger comprising an inlet chamber, a bundle of tubes encased in a shell structure, and an outlet chamber, wherein (a) each tube comprises an inlet with a diameter of d1, a longitudinal middle part with a diameter of d2, and an outlet, and (b) d1 is larger.

11. The apparatus of claim 1, wherein the reactor is a fluidized-bed reactor comprising a fluidized bed of polyolefin particles and a fluidization grid at the bottom of the reactor.

12. The apparatus of claim 1, wherein the reactor is a multizone circulating reactor, wherein, in a first polymerization zone, growing polyolefin particles flow upwards under fast fluidization or transport conditions, and wherein, in a second polymerization zone, growing polyolefin particles flow downward in a densified form, and wherein the first polymerization zone and the second polymerization zone are interconnected, polyolefin particles leaving the first polymerization zone enter the second polymerization zone, and polyolefin particles leaving the second polymerization zone enter the first polymerization zone thereby establishing a circulation of polyolefin particles through the first and the second polymerization zones.

13. The apparatus of claim 1, wherein the recycle line free of a cyclone for gas/solid separation.

14. A process for preparing an olefin polymer comprising the step of homopolymerizing an olefin or copolymerizing an olefin and one or more other olefins at temperatures from 20 to 200° C. and pressures from 0.5 to 10 MPa, in the presence of a polymerization catalyst, wherein the process is carried out in an apparatus of claim 1.

15. The process of claim 14, wherein the process is carried out at a reaction gas stream velocity of from 5 m/s to 25 m/s.

16. The process of claim 15, wherein the process is carried out at a reaction gas stream velocity of from 15 m/s to 20 m/s.

17. The process of claim 14, wherein the fluidization velocity in the reactor is 0.3 to 1.5 m/s.

18. The process of claim 16, wherein the fluidization velocity in the reactor is 0.5 to 1.2 m/s.
